(19) United States
(12) Patent Application Publication
(10) Pub. No.: US 2013/0325517 A1
(43) Pub. Date: Dec. 5, 2013

(54) Insurance Systems and Method Using Online Social Networks

(71) Applicant: Gregory Berg, New Haven, CT (US)

(72) Inventor: Gregory Berg, New Haven, CT (US)

(21) Appl. No.: 13/677,807

(22) Filed: Nov. 15, 2012

Related U.S. Application Data
(60) Provisional application No. 61/560,484, filed on Nov. 16, 2011.

(51) Int. Cl. G06Q 40/08

(52) U.S. Cl. CPC G06Q 40/08
USPC 705/4

(57) ABSTRACT

A system for providing insurance policies is disclosed herein that includes an insurance database storing user information for a group of users in an insurance program, including user identity data and user reputation data, and an insurance program server containing an insurance platform application communicating with the users in the insurance program through a social network web site and accessing user identity data through a social network database. The application provides insurance policies issued by an insurance carrier to the users covering a first insurance policy term, and uses risk reputation rating data about an individual user submitted by the individual user and scored by the insurance platform application for the purpose of removing selected users from the group for a second insurance policy coverage term. Additional systems and methods are also disclosed.

### BACKGROUND

The embodiments disclosed herein relate to systems and methods for manipulating data to initiate and facilitate transactions between users of a social network and one or more service providers.

Conventional insurance companies pool risks of separate individuals, groups or businesses that do not communicate with one another when buying insurance. The advantage of this type of conventional arrangement is that the insurance company can charge different premiums to different people or entities depending upon the level of risk being insured, and individuals are not required to expend substantial effort to obtain insurance coverage.

An alternative to conventional insurance involves groups of individuals who are acquainted with one another through social networking. The social network groups insure their own group members up to a particular limit. The seller of the insurance has suggested that this system reduces insurance costs to the consumer because individual are less likely to file insurance claims for small amounts, and are unlikely to file fraudulent claims.

It would be useful to provide improved systems and methods for efficiently providing insurance through online networks.

### SUMMARY

One embodiment is a system for providing insurance policies, comprising at least one insurance database storing user information for a group of users in an insurance program, including user identity data and user reputation data, and an insurance server containing an insurance platform application communicating with the users in the insurance program through a social network web site and accessing user identity data through a social network database, the application providing insurance policies issued by an insurance carrier to the users covering a first insurance policy term, and using risk reputation rating data about an individual user submitted by the individual user and scored by the insurance platform application, the platform application providing individual user reputation data to other users for the purpose of removing selected users from the group for a second insurance policy coverage term.

Another embodiment is a method of managing an online insurance program, comprising forming a first electronic user group of at least 50 users, managed by an insurance program facilitator, in which each user contributes a predetermined first quantity of funds and/or services and receives a first commodity in exchange for the funds and/or services, after a determined time period, receiving computerized instructions from the users in the group for removing selected members from the electronic user group, removing the selected members from the electronic user group to form a revised electronic user group, using a first computerized simulation to transform data representative of the cost of the commodity per user for a particular time period for the users in the revised electronic user group, disseminating the transformed data to the insurance program facilitator, and providing a second commodity to the members of the revised user group in exchange for a second quantity of funds and/or services contributed by each member of the revised user group.

A further embodiment is a method comprising identifying a group of potentially insurable individuals, providing a third party administrator, configuring the individuals in the group and the third party in a hub arrangement, providing insurance at a first premium rate to a subset of the individuals through a carrier using the third party administrator, sending a query to the insured individuals at a future time to determine which members of the group are to be removed from the group, receiving data from the individuals in the group indicative of insured individuals to be removed from the group, removing selected individuals from the group, using computerized simulation to transform historical loss data and perform one-tail tests on the data, and providing insurance at a second premium rate that is lower than the first premium rate to the subset of individuals. The simulations can include, for example, Monte Carlo simulations and/or Stochastic methods.

Another embodiment is a computer system comprising a data storage memory, an operating system for accessing data in the memory, an application program compatible with the operating system, and a user interface for the operating system and application program. The computer system comprises a database stored in the memory containing member data, at least a portion which presents a quantitative indicator value indicative of the level of risk for insuring a particular individual. The system also includes executable instructions for combining, with weighted importance, the quantitative indicator values of the group members, executable instructions for computing insurance premium data for the group with and/or without including the riskiest members of the group, and executable instructions for receiving votes to remove group members to reduce group risk.

An additional embodiment is a method of establishing an insurance pool comprising obtaining potential insurance pool member profiles over the internet using a social network accessible using a computer, sending electronic invitations to potential insurance pool members to join an insurance network that is a subgroup of the social network, and managing insurance member network reputations, and/or providing rewards to members for network participation, wherein the insurance pool is established and managed using a computer, and group members can remove particular group members by voting.

Yet another embodiment is a method to develop, refine and/or disseminate insurance loss control information using a website established using a computer, wherein the website allows for the creation and editing by insurance policyholders of interlinked web pages via a web browser using at least one of mark-up language and a text editor.

A further embodiment is a method of generating actuarial data comprising using an online social network on a computer to establish a risk pool, and calculating the probability of losses due to insurance claims using the computer.

Yet another embodiment is an insurance program or system comprising a plurality of unique risk pools set up using computer software that obtains data over the internet, wherein the profitability of each risk pool is calculated individually using a computer.

Another embodiment is a computer implemented insurance program or system wherein the policyholders in the program determine inclusion or exclusion of other members of the program or system by voting using a computer.

A further embodiment is an insurance program or system wherein each member is provided with a risk reputation based on a scoring system, wherein each member is part of the same online social network accessed using a computer.

Yet another embodiment is an insurance program or system in which risk management data is collected and disseminated via online social networks on a computer.

Another embodiment is a computer-implemented insurance program or system combining the concepts of mutual insurance and social networking using a computerized network system.

### BRIEF DESCRIPTION OF THE DRAWINGS

FIG. 1 schematically shows a computer system for implementing an embodiment disclosed herein.

FIG. 2 schematically shows a first embodiment of a method described herein.

FIG. 3 schematically shows a second embodiment of a method described herein.

FIG. 4 schematically shows the structure of a loss control program described herein.

FIG. 5 schematically depicts the relationship of various computer programs used in embodiments described herein.

### DETAILED DESCRIPTION

A new set of insurance systems and business methods are described herein that use online social networking functions to assemble low-cost insurance programs, continuously improve the risks and costs in those insurance programs, and give policyholders greater control over their insurance. The business methods apply to business insurance, including but not limited to workers compensation, general liability and property, auto liability and physical damage, and specialty lines, and to personal insurance, including but not limited to homeowners and renters, auto, short-term disability and long-term disability insurance.

The systems and methods described herein use a number of online social networking functions, including but not limited to profiles, friending, invitations, liking, social savings, Wikis, location, reputation and viral marketing. Each of these functions is currently being used in a variety of internet-based social media and social networking businesses. The embodiments described herein modify and adapt the use of these functions in an entirely new way to create insurance management programs for members of online social networks.

In accordance with the embodiments described herein, online social networks including but not limited to the social net and social media, are used for product development product distribution, and administration.

### Definitions of Terms:

Aggregator: a person, or firm, or association that has been certified by the Insurance Facilitator, after training, to promote the establishment of Programs.
Application (noun): a specialized computer program, downloadable onto electronic devices, that is designed to help a user perform a specific task.
Candidate: a person or firm that has created and published a Risk Profile and is eligible to become a Member of a Program.
Computer: a PC, mobile device, laptop, or other electronic device capable of electronically connecting to other electronic devices and processing data.
Electronic Communications Network: a computerized system that interconnects computers and/or organizational computer facilities that are positioned at multiple locations.
Individual: a single person or a single business entity.
Insurance Facilitator: an insurance services and technology company that operates an online insurance business, using an associated technology platform. The technology platform supports one or more online Insurance Programs.
Insurance Program (Program): an online risk sharing and risk control community of Members bounded by Program eligibility criteria, and, which operates on the technology platform.
Member: a person or firm that is a participant of a Program.
Member Assembly: a periodic online meeting, weblog, chat room or other set of electronic communications at which members of a Program establish or re-establish Members' Consensus.
Member Invitation: a formal offer from a Member to a Candidate to join a Program, subject to Members' Consensus.
Members' Consensus: a majority position, established by online polling, on whether a Candidate should be admitted into a Program, and whether a Member should remain in a Program.
Online Social Network: a set of data available to an interconnected network of computer users that interact with one another and share information, including identifying information, within the bounds of the network. The information can be accessed through a computer system which provides access to the members of the network.
Online Social Networking: interacting with, and joining groups with, other users of an online social network.
Pledge: a signed statement by a Candidate or Member agreeing to certain behaviors in a Program. The Pledge is one element of the Risk Profile.
Program Sponsor: a person, company or firm that has paid a fee to advertise its products or services to Members on a Program computer site. Many Program Sponsors will be prospective Unbundled Service Providers.
Risk Profile: a risk identity created by a Candidate or Member and made available to Members of a Program.
Risk Reputation Rating: a combination of factual scores, and subjective opinions among fellow members. Member Reputation adheres to the Member Risk Profile and is a critical element in maintaining Members' Consensus.
RiskWiki: a Program electronic “page” on a risk management topic that is created and continuously edited by Members and Program Sponsors. Topic areas will include exposure identification, risk evaluation, and loss control.
Unbundled Service Provider: a person, company or firm under contract to the insurance facilitator or a Program to provide a service. Examples include fronting carriers, third party claims managers, accountants, and investment managers.

The insurance facilitator and its related companies will at times perform one or more of the following roles: insurance program manager, retail insurance broker, managing general agent, reinsurance intermediary, reinsurance company, and technology service provider. Depending on the roles being performed by the insurance facilitator on a particular insurance program, the data elements to be exchanged between the insurance facilitator server and the user's computer, and the data exchanged between the insurance facilitator server and the insurance company server and the data exchanged between the online network server and the insurance facilitator server will vary according to the specifics of that insurance program and the particular roles being played by the insurance facilitator on that insurance program. In one nonlimiting example, the insurance facilitator interacts with both the users who purchase insurance and with the insurance company, but does not handle the underwriting or the claims. In another nonlimiting example, the insurance facilitator conducts underwriting and handles claims for the insurer.

In some embodiments, the insurance facilitator has two sources of income, namely program fees calculated as a percent of “gross premium under management”; and a percentage of advertising revenue from program sponsors. In some embodiments the insurance facilitator will take an underwriting risk. In this case, all of the underwriting risk can reside inside of a Program, or the risk can be apportioned among the Issuing Carrier, the Member-Owned Reinsurance Company (if any), the insurance facilitator and/or any Outside Reinsurers. In other embodiments, the insurance facilitator will not take an underwriting risk.

In embodiments, each Member of a Program gets insurance at a lower cost than would be paid for the same coverage for a conventional insurance policy and may share in profits of the Program. Some programs may be structured so that the Members own their Program. The low cost is due to no agents' commissions, low capital requirements for the Member-owned reinsurance company, competitive bidding for each Unbundled Service Provider, operational efficiencies on the insurance facilitator's platform, advertising revenue from Program Sponsors, and the positive leveraging effects of Social Savings.

As a number of Programs accumulate on the insurance facilitator's platform, the value of the insurance facilitator's company increases. The insurance facilitator is highly scalable.

### Value Proposition

The insurance facilitator has a strong value proposition, with the following elements of value:
Lower upfront cost for insurance coverage. These cost reductions are the result of the lower insurance facilitator expense ratio, and the risk improvement that occurs in each program due to friending/de-friending. The insurance facilitator will operate at a lower expense ratio because it will not need to pay agents commissions or engage in expensive television advertising.
Coupons provided to program members at the end of each coverage period, if loss experience is better than expected. Coupons can be used for subsequent coverage periods or provided to friends as an incentive to join the program.
Transparent and simple pricing.
An engaging online user experience that is a natural extension of the consumers' already active online social networking.

In embodiments, the insurance facilitator allows the members of its insurance programs to share in the underwriting results of their Programs. Today, in some alternative insurance arrangements, such as pools and captive insurance companies, there is the opportunity for members to share in the underwriting results. However, none of these entities do so inside of the online social networking method described herein.

Each Program will be structured so that the Members' final cost is a function of the actual loss experience of all members combined in that Program. This will be accomplished by either (a) a profit sharing arrangement with the fronting carrier, or (b) the use of a group captive arrangement with the fronting carrier. Under a group captive arrangement, the Members establish a reinsurance company (the “captive”) that reinsures a portion of the risk of the fronting carrier. This captive arrangement is an existing risk financing technique, but has never been used in the online social media-based business method described here.

### Cost Savings

The disclosed embodiments enable the purchaser of insurance to realize substantial cost savings as compared to the purchase of a conventional insurance policy. Each Program has an annual budget for loss costs and operating expenses, and each Member is allocated a share of total expenses. Each Member pays a conventional premium to the fronting carrier. This premium will conform to state rate regulations. In embodiments, the Members will view this premium as an initial deposit on their cost of insurance for that year. The Members' final net cost of insurance will be a function of the shareholder dividends, if any, paid to Members by the Member-owned reinsurance company.

Each Program on the insurance facilitator's Platform will have the ability to attract Program Sponsors and the associated advertising fees. Non-limiting examples of Program Sponsors include persons and firms that want to provide services as an Unbundled Service Provider, insurance companies that offer special coverages and “companion lines” not available through the program, vendors of goods and services for safety and loss control, and vendors of products and services unrelated to insurance and risk management but relevant to the program customer segment. In embodiments, the insurance facilitator manages all advertising relationships on behalf of Programs.

In one scenario, advertisers will pay a fee for advertisements, with the fee being based, for example on type of the product or service being advertised, the number of computer users who will see the advertisement, the geographic location and demographic characteristics of the target audience, etc. Advertising fees typically will be apportioned between a Program and the insurance facilitator.

System and Method for Assembling Policyholders into Risk Pools/Insurance Programs:

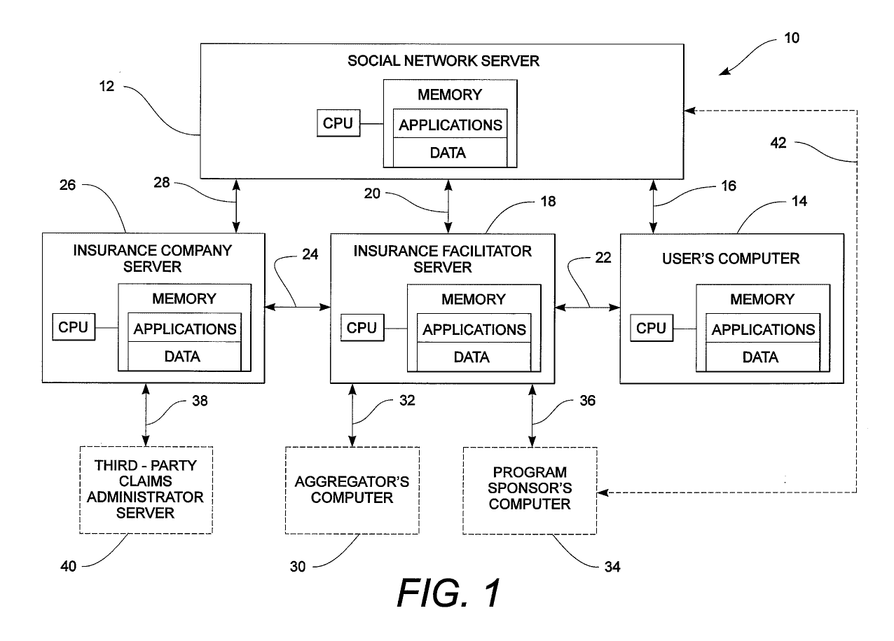

Referring to FIG. 1, a system according to a first embodiment is shown and is designated as 10. The overall system relies upon interactions and data exchanges among and between the Insurance Facilitator Server, the Online Social Network Server, the User's Computer, the Insurance Company Server, and optionally also a Third-Party Claims Administration Company Server, an Aggregator's Computer, and a Programs Sponsor Computer. The system is used as described below. A social network server 12 is electronically connected to a user's computer 14 via the internet or another electronic communications network system through a connection line 16, which can include wired and/or wireless communcations. The social network server 12 also is electronically connected to the insurance facilitator server 18 through a communication line 20. When a prospective member (user) applies for membership based on an invitation from a member, the prospective member communicates with the Insurance Facilitator through the Insurance Facilitator Server 18, either via the Social Network Server 12 or directly through communication line 22. The Insurance Facilitator Server 18 communicates with the insurance company through a communication line 24 with the Insurance Company Server. The Insurance Company Server 26 optionally is electronically connected to the Social Network Server 12 by a communication line 28, although in many embodiments there is no direct contact between the insurance company and the social network server. In some cases, the Insurance Facilitator Server 18 is electronically connected to an aggregator's computer 30 by communication line 32, and in some cases the Insurance Facilitator Server 18 is electronically connected to a program sponsor's computer 34 by a communication line 36. In some embodiments, the insurance company uses a third-party claims administrator, which communicates via electronic communication line 38 with a third party claims administrator server 40. In some cases, the program sponsor's computer communicates directly with the social network server via communication line 42. Each server has a CPU that is connected to a memory, a display (not shown) and a keyboard (electronic or physical—not shown). Each memory includes applications and data.

When a user applies for membership after having received a member invitation, their application data is transmitted from the computer 14 to the social network server 12 and then to the Insurance Facilitator Server 18, or is transmitted directly from the user's computer 14 to the Insurance Facilitator server 18. Personnel at the insurance facilitator then process the incoming data and make a determination about membership in the group. If a membership invitation is extended, data indicative of the offer for insurance in some embodiments data is transmitted directly to the user, without going through the social network server, in the form of an offer for insurance. Alternatively, communication is transmitted from the Insurance Facilitator Server 18 via communication line 20 to the Social Network Server 12, and then onward via communication line 16 to the User's Computer 14. In many cases, the insurance offer includes a policy that will become bound if a premium is paid. At this point, if the user decides to join the Group, they will create a login, usually with the insurance facilitator server and pay a premium, usually to the insurance facilitator server, using an online payment system. The policy coverage becomes effective either when payment is received, or when the user receives written electronic confirmation that coverage is bound. The user prints, saves and/or otherwise retains their insurance policy on the user's computer 14 and/or in hard copy form.

The aggregator's computer 30 interacts with the Insurance Facilitator Server 18 and a processor associated therewith along electronic communication line 32 to transmit data indicative of potential new groups and to receive responses from the insurance facilitator 18. The Program Sponsor's Computer 34 interacts with the processor of the insurance facilitator server 18 along a communication line 36, with data being transmitted in both directions. In embodiments, the Insurance Company uses a third party claims administrator 40 to handle claims. The Insurance Company Server 26 electronically communicates with the Third-Party Claims Administrator Server though an electronic communication line 38.

In one embodiment, the insurance obtained by the user is auto insurance. In another embodiment, the insurance obtained by the user is renter's insurance.

In embodiments, the user learns of an existing insurance program through a source other than an online friend, and the user requests an opportunity to join an established insurance group on a social network. In this scenario, the first contact by the user is with the Insurance Facilitator by way of the social network server. On the user's computer, the user enters the online social network site and registers a username and password (if not already registered). The user indicates to the insurance facilitator server that the user is interested in buying insurance through an insurance facilitator insurance program by establishing status as a Candidate. The user establishes candidacy by completing a risk profile. When the insurance being sought is automobile insurance, the risk profile includes a number of data elements, including but not limited to, name, address, age and vehicle description. The user also indicates an agreement to allow the insurance facilitator server to access 3rd party sources of underwriting information such as prior claims experience, motor vehicle records, and credit history. When the insurance being sought is renter's insurance, the risk profile includes a number of data elements, including but not limited to, name, current address, prior addresses, age, type of residence, number of units, number of occupants, copy of lease agreement, etc. The user also indicates an agreement to allow the insurance facilitator server to access 3^{rd} party sources of underwriting information such as percent owner occupany of a building, building owner name and address, identity of other buildings owned by the same party, etc.

The programs grow (in the number of insureds) through networking. In embodiments, any person or business that meets the Program eligibility requirements can automatically be deemed a Candidate. A Candidate can create and publish a Risk Profile at any time. In embodiments, a Member can invite a Candidate to become a Member (Friending), so long as that Candidate has published a Risk Profile. The insurance facilitator establishes a standard Invitation process.

In embodiments, once a Candidate has been friended by a Member, that Candidate's membership in the Program is subject to Membership Consensus, and is subject to other underwriting criteria that may be established by the insurance facilitator. Candidates are provided with a method to contact Members to request Invitations. A person or business that does not meet the eligibility requirements of an existing Program, but who is interested in the insurance facilitator concept, will be referred to an Aggregator as a prospective founding member of a new Program. As the size of a Program increases, and as the risk composition of the Members improves, each Member gets a lower deposit premium and larger shareholder dividends.

### Role of the Insurance Company and the Use of Social Savings

Each insurance program will have a set of insurance service providers. This “unbundled” service provider model is already used successfully by most alternative market insurance entities such as pools and captive insurance companies. The insurance facilitator will establish and maintain these service provider relationships on behalf of the insurance programs.

### Issuing Carriers

Each insurance program has a contract with a highly rated insurance company to act as the issuing carrier. Two different approaches are applied to the development of insurance programs in order to make full use of the positive affects of social savings (social savings is used by companies such as Groupon and LivingSocial to create purchasing leverage by being able to deliver blocks of customers to a company at one time). In a first embodiment, the insurance facilitator identifies an insurance company to be the issuing carrier and then assembles the insurance program to be insured by that carrier. In this case the prospective policyholders know who the insurance company will be in advance. In this case there are some social savings components that are similar to the power of group purchasing. However the insurance company does not have to compete for the business under this alternative. In a second embodiment, the insurance program is assembled first and then the program is shopped by the insurance facilitator to several insurance companies. This creates a competitive situation. The lowest insurance company bidder wins, which creates significant social savings for the Members.

### Use of the Member Risk Profile

Every Candidate and Member creates, maintains, and publishes a Risk Profile. While in Candidate status, the Risk Profile is anonymous. While in Member status, the Risk Profile may or may not be anonymous depending upon that program's membership guidelines.

The insurance facilitator establishes a standard Risk Profile template. However, each Program will have custom features on the profile template, reflecting the unique risk exposures of that program's eligibility requirements. The Risk Profile will include information on risk exposures of the Candidate/Member, including geocoding, actual loss experience: in the aggregate and individual large losses, information that is similar to that required in conventional insurance applications and submissions, only pared down to essential elements (such as type of auto, location of auto, and age of driver), badges, i.e. symbols of special Member recognition for accomplishments and/or input, including but not limited to Candidate referrals, contributions to member-generated content, and number of years in the Program. In embodiments, the Risk Profile makes use of multimedia content. Key information on the Risk Profile will be independently verified by the insurance facilitator. For example, for automobile insurance, key information will include driver history of traffic accidents and tickets, and credit rating. In embodiments, the Risk Profile also includes the insurance facilitator Pledge and the Risk Reputation Rating.

### The Member Pledge:

In some Programs, the Pledge will be a requirement of continued membership, and thus a Risk Profile is not complete until the Candidate or Member has signed the Pledge. The Pledge is a standardized statement that includes one or more of the following: a certification that all information on the Risk Profile is correct, an agreement that opinions provided on other Members' Reputation will be well intentioned and well informed, an agreement to participate on the Board of Directors and/or appropriate committees, an agreement to be an active contributor to Member-generated content for loss control, and an overall commitment to act in the spirit of joint cooperation and mutual self-interest. The degree of compliance with the Pledge helps to shape Reputation. A non-limiting Example of a Pledge is: “As a Member, I have agreed to make my net insurance costs subject to the actual loss experience of other Members. We are all friends in risk management; and all of my behaviors inside the Program will be aligned with reducing the costs of insurance.”

### Member and Program Reputation:

Each Member has a Reputation determined by the insurance facilitator that is established using a standardized insurance facilitator methodology. The Member Reputation adheres to the Member Profile, and in embodiments is a combination of factual scores, based on actuarial analysis, and subjective opinions among fellow Members. The insurance facilitator provides guidance to Members on how to reach an opinion on another Member's reputation, and on how to manage their own reputation. Each Member's Risk Profile and Reputation will be a predominant factor in the outcome of Member Consensus during Member Assembly. The insurance facilitator will develop online training modules in reputation management. This will provide guidance to Members on how to reach an opinion on another member's reputation, and on how to manage their own reputation. Each Member's Risk Profile, which includes reputation, will be the predominant factor in the outcome of Member Consensus during Member Assembly. The Member Reputation concept is important to the insurance facilitator model, because the model is heavily dependent on maintaining peer pressure to keep loss experience as low as possible and to continually remove poor performing members and add good performing members.

The “sum” of all members' reputation in a specific insurance program creates an implicit Program Reputation. A positive Program Reputation can attract more interest and better terms from Unbundled Service Providers and more Program Sponsors.

### EXAMPLE 1

### Establishment of Member Reputation and Program Reputation

In many cases, each member of a program has a Reputation. In one non-limiting embodiment, the reputations are categories as Platinum, Gold, Silver, Bronze and Probation. The Reputation of a member is determined by a set of Risk Elements and a set of Behavior Elements. In the context of auto insurance, for example, risk elements include motor vehicle record (externally sourced), credit score (externally sourced), vehicle information (provided by member), driver information (provided by member), and location information (provided by member). Behavior Elements include the following: ability to recruit new members with good loss experience, ability to recruit new members who also get new members, participation in voting, active in the group network.

After a predetermined term, a nonlimiting example of which is six months, each member's reputation is re-assigned to a category. A forced distribution of risk reputation ratings is used by the insurance facilitator to assign members in a Program to categories, with the total being 100%:

10-20% Platinum

15-25% Gold

25-35% Silver

15-25% Bronze

5-20% Probation

In embodiments, each member of a group can see the reputation category of each other member. In embodiments, the insurance carrier can see the reputation category of each member of a group. In some cases, each member of a group can see the details of how they were assigned to their reputation category, how they can improve their reputation, and the progress they are making in that improvement. The Insurance Facilitator can see the individual data elements comprising the reputation.

Reputation and reputation distribution is used for setting premiums, determining eligibility for, and amount of dividends, determining eligibility for, and amount of promoter incentive awards, determining continued eligibility for membership, and determining amount of discounts for advertisers' products.

In some embodiments, each program has a Program Reputation, which is based on the forced distribution, usually by the carrier, of all groups into reputation categories.

The Member Reputation concept is beneficial to the insurance facilitator model, because the model is heavily dependent on maintaining peer pressure among members to manage their risk and to avoid insurance claims. This will reduce the loss experience in the Program. The “sum” of all Members' Reputation in a Program creates an implicit Program Reputation. A positive Program Reputation can attract more interest and better terms from Unbundled Service Providers, and more Program Sponsors.

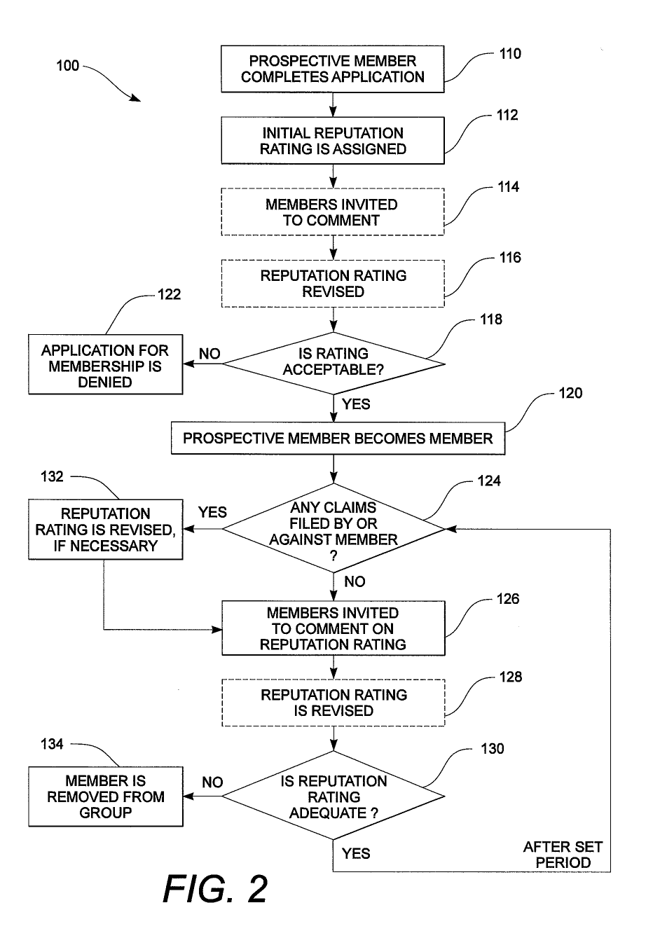

A typical process in which Individual Reputations are established is depicted in FIG. 2. The overall process is designated at 100. A prospective member completes an application for insurance at 110. Based on the contents of the application, combined with any data obtained from other sources, an initial risk reputation rating is assigned at 112. Members are invited to comment on the rating at 114. Based on the comments, the risk reputation rating may be revised at 116. Next, a determination is made as to whether the rating is acceptable at 118. If the rating is acceptable, the prospective member is given the opportunity to pay the insurance premium and join the group and, in most cases, becomes a member at 120. If the rating is not acceptable, the prospective member's application is denied at 122.

After a set period, for example 6 months, a query is conducted at 124 as to whether any claims have been filed against the member. If not, the other members are invited to comment of the risk reputation rating of the individual at 126. If appropriate based on the comments, the reputation of the member is revised at 128. If, at 130, the reputation is high enough to remain in the group, the member stays in the group. If necessary, a new premium will be paid.

If a claim has been filed by or against a member at 124, the member's risk reputation rating is revised, if a change is warranted, at 132. Other Members are then invited to comment on the reputation of the member at 126. If appropriate, the risk reputation rating is revised at 128. If the risk reputation rating is adequate, the member stays in the group, and after another set period, e.g. 6 months, the claims review is again conducted at 124. If the reputation is inadequate, the member is given notice at 134 that they will be non-renewed when their term of their insurance policy ends.

### EXAMPLE 2

### System and Method for Risk Portfolio Management

An insurance enterprise must continuously manage its “book of business” to ensure profitability. This is also known as risk portfolio management. In the embodiments disclosed herein, risk portfolio management is handled in a highly innovative and unique manner: it makes use of the “friending/de-friending” concepts in online social networks:

A Candidate must obtain Members' Consensus to join a Program as well as meeting any other underwriting requirements that may be established by the insurance facilitator. Akin to “defriending” on Facebook and deleting “contacts” on Linked In, a Member will be expelled from a Program if the Member cannot maintain Members' Consensus. A Program will have periodic Member Assemblies, when the window opens for friending and defriending. The Members' Consensus will be heavily influenced by a Member Profile and by Member Reputation. The insurance facilitator can use algorithms to establish Reputation. In embodiments, the insurance facilitator uses dynamic financial analysis (DFA) methods, and applies the concepts of the efficient frontier to risk

### EXAMPLE 3

### Market Segmentation

The insurance facilitator uses market research to identify target market segments of persons and firms. The analysis will include assessments of the likelihood of prospective insureds being attracted to the insurance facilitator model, and the desirability of a group of insureds being part of the same insurance program. The results of market research will be provided to Aggregators. Aggregators will also be provided with an “application package” to enable Program creation. Some Programs will be homogeneous, while others will be heterogeneous.

Non-limiting examples of homogeneous Programs include: Personal and business insurance for graduates from computer science programs in the last five years: “Computer Science Insurance Program,” Personal and business insurance for members of LinkedIn Global Private Equity & Venture Capital Group: “VC Insurance Program,” and Personal and business insurance for owners and employees of Subway Franchises: “Footlong Insurance Program.”

Non-limiting examples of heterogeneous programs include:
Personal and business insurance in the State of Colorado, exclusive to a particularly important Aggregator: “Andromeda Insurance Program,”
Personal and business insurance for employees of Google: “Leo Insurance Program,” and
Commercial property insurance for businesses in Florida: “Gemini Insurance Program.”

In some Programs, Members will Share in the Underwriting Profits of their Programs.

In embodiments, Programs will be structured so that the Members' final cost is a function of the actual loss experience of all members combined in that Program. This will be accomplished by either (a) a profit sharing arrangement with the fronting carrier, or (b) the use of a group captive arrangement with the fronting carrier. Under a group captive arrangement, the Members establish a reinsurance company (the “captive”) that reinsures a portion of the risk of the fronting carrier. This captive arrangement is a well established risk financing technique today, but has never been used in an online insurance program.

### EXAMPLE 4

### Establishment of a New Program

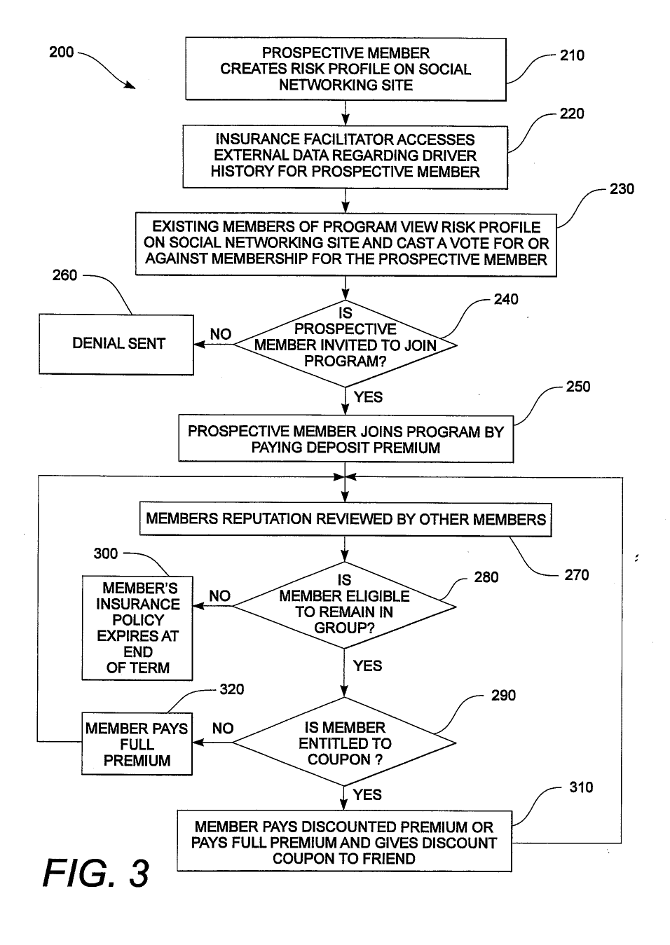

One example of a potential customer segment is auto insurance for “any person who is a current or former student of Rockport University (a “Rockport Tiger”).” Using TigerAuto as an illustration, the actual customer experience is described below in FIG. 3.

The overall process is designated as 200. An eligible candidate who is interested in joining an online insurance program creates a risk profile on a social networking site, such as Facebook, Linkedln, Google Chrome, or another internet or intranet at 210. This is just some additional information added to the online identity that they have already posted. The new information includes a description of their car and their driving habits. The insurance facilitator then automatically pulls in from external sources information including prior motor vehicle accidents, traffic tickets, etc. at 220.

The preliminary risk profile is now visible to all of the other candidates and members of TigerAuto. The members then use the insurance facilitator's online polling system to vote on each candidate's admission to the program, referencing the information in the risk profiles, at 230. The results of the voting at 240 determine whether the prospective member is invited to join the program. If the prospective member is invited to join and joins at 250, they pay the deposit premium. If the prospective member is denied, the process ends at 260.

Then, every 6 months or at another specified interval, the members review the reputations of the other members and vote at 270 on who can stay in the program and who will be removed from the program. After a determination is made at 280 for each member individually, those remaining in the program may be eligible for a coupon at 290. Others will be asked to leave the program at 300.

Over time each member earns a reputation score that is based on their driving experience, how long they have been members of the group and how engaged they have been in the program. For example, an engaged member would have been active in the online polling and in recruiting new members into the program. This reputation score, which is now part of their profile, is seen by all members and helps in the online voting. This innovative process gives lots of control to the members. They will naturally balance their desire to see the program grow with the need to prune the poor performers.

The insurance facilitator also sets up a group dynamic where each member wants the group to get bigger, because that's good for everybody, but also each member wants just the right mix of members so that there are fewer claims. Good loss experience translates into coupons for members at 310. Average loss experience results in retention in the program at 320 without a discount coupon. Also the actual pricing for each individual is a function of the size of the group is and its overall risk quality.

There are two parts to the insurance price in TigerAuto: the deposit premium and coupon. The deposit premium is what is paid up front at 250. Almost all of the members have seen a lower going in premium from TigerAuto compared to their old insurance company premium. This is not surprising because the insurance facilitator operates with a much lower expense ratio. The insurance facilitator does not use insurance agents and therefore does not pay agent commissions. Furthermore, the insurance facilitator and carrier do not choose to pay for TV advertising because the marketing is affected by the members of the group.

The second part of the price is the coupon. Each member of TigerAuto is eligible to get a coupon every period, e.g. every 6 months, based on their own loss experience and the overall loss experience in the group. Also, the amount of the coupon is affected by growth in the program. Coupons can be applied to the next deposit premium, or can be given to a friend to encourage them to join the group. In embodiments, the coupon system creates a strong incentive for the members to grow the program and to keep their claims experience down. Coupons also encourage existing members to be selective at to who comes into the Group and who should be voted out. This is an application of the social savings concept.

The insurance facilitator has an agreement with an A+ rated insurance company that is licensed in Alabama, Alaska, Arizona, or another state or set of states. The company has agreed to let the insurance facilitator underwrite on its behalf and provide customer service. This means that the TigerAuto members get an insurance policy from a highly rated company, and the insurance facilitator runs the insurance program.

### EXAMPLE 5

### An Insurance Company Owned and Run by the Insurance Facilitator

The insurance facilitator can establish its own mutual insurance company, to be owned by the members of the programs. In this scenario, the members receive an annual rebate from the insurance company if there is a surplus at the end of the annual accounting period.

### EXAMPLE 6

### Recruiting New Group Members

Sales and marketing for new Programs are established by Aggregators, in cooperation with the insurance facilitator. In embodiments, the Aggregators are provided with applications, created by the insurance facilitator, for Program development. In embodiments, some Aggregators are given exclusive access to specified customer segments. Marketing usually is through electronic communication. Candidates are attracted to Programs by invitations from Members, Social Savings initiatives, and Viral marketing initiatives. Social Networking Potential (SNP) tools will be embedded in the marketing and sales plans. Online social savings is highly relevant to the creation of risk pools, due to the “law of large numbers”. The more exposure units (number of autos, for example) in a Program, the lower the risk margin around expected values of loss. The insurance facilitator can use pre-existing online social networks to produce increases in awareness of the insurance facilitator's brand. In addition, The insurance facilitator will create and launch viral promotions including video clips, interactive Flash games, eBooks, and text messages. SNP is a numeric coefficient, derived through algorithms, to represent both the size of an individual's online social network and their ability to influence that network. SNP can enhance viral marketing strategies.

### EXAMPLE 7

### Loss Control

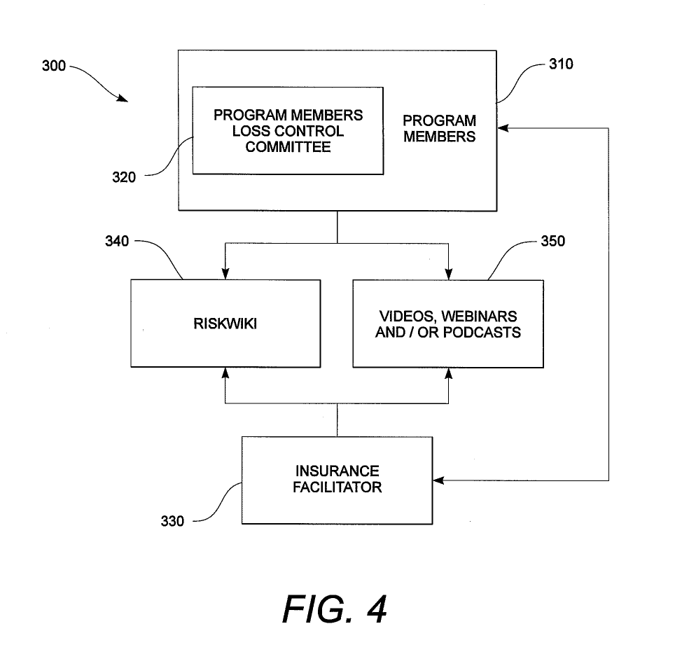

Loss control programs are an inherent method in insurance programs for reducing the frequency and severity of claims. In embodiments described herein, the method has a new and unique approach to loss control. As is shown in FIG. 4, in some cases, loss control programming and content will be created and disseminated by members. In some cases, each Program has a Loss Control Committee 320, composed of a subset of Program Members 310, and staffed by the insurance facilitator 330. The loss control delivery mechanisms can include RiskWikis at 340, and Videos (including “How To's”), Webinars, and Podcasts at 350. In embodiments, all content can be created by Members and will have search capabilities. In some embodiments, Members are eligible for Loss Control Achievement Awards, symbolized with Badges on the Risk Profile. Members' contributions to the creation and editing of loss control content will improve Reputation on the Risk Profile. In embodiments, the insurance facilitator establishes a “Guide to RiskWikis”, modeled after the Wikipedia Manual of Style.

### EXAMPLE 8

### Member Management of Risk Pools

The embodiments described herein are new in that they combine the concepts of mutual insurance with online social networking. Furthermore, they use the following online social networking functions to establish and maintain high quality insurance pools that are largely owned and operated by the members of the networks: Member profiling, Invitations to join networks, Member reputation, and Member rewards for network participation. The Wiki concept is used to develop, refine, and disseminate member-generated loss control information. Group social savings concepts are used to attract members to establish risk pools that have a sufficient size to allow for actuarial estimates of expected losses, and the probability distributions of losses around the expected values. In some Programs, the insurance program is owned by the members/policyholders, and operates entirely in the internet or an intranet system (no “bricks and mortar”).

Some insurance companies and programs are currently making use of social media and social networking for advertising, and for tracking policyholder opinion. However, no insurance companies or programs are actually using social networks to establish member-owned pools of risk (insurance programs), nor using the key functions of social networks to manage the risk profile of these insurance pools.

The new insurance programs are formed as unique risk pools, whereby the profitability of each risk pool is measured individually.
In addition, the embodiments are new, in the following ways:
The policyholders in each risk pool control which prospective policyholders may enter the pool and which policyholders are expelled from the risk pool.
The policyholder control over the entry and exit of prospective policyholders is exercised via an online “member assembly”, supplemented by underwriting criteria established by the insurance facilitator. Continued participation in a risk pool requires “member consensus” which is measured by an online voting process during the member assembly.
The member assembly process results in risk portfolio optimization; the quality of the risk pool improves on a continuous basis.
Each prospective policyholder (a “candidate”) creates a unique “risk profile” that is for the sole purpose of participating in a risk pool. This risk profile is different, and supplemental to, any member profiles that have already been established on the online network.
Each member signs a “pledge” agreeing to certain risk prevention behaviors in a program. The pledge is one element of the risk profile. “Risk reputation” is established for each member, using a proprietary scoring system combined with subjective opinions of all other members in the program.
Programs are created through the use of “aggregators”, which are persons or firms that have been certified by the program.
Insurance services for each program are provided by unbundled service providers. Examples include fronting carriers, third-party claims administrators, accountants, actuaries, and investment managers.

### EXAMPLE 9

### Participation by Program Sponsors

One source of income for the insurance facilitator is fees paid by program sponsors who want to advertise products or services on a program's electronic “page.” In embodiments, program sponsors will assist the insurance facilitator and its programs use the wiki methodology to create, continuously improve, and publish information on exposure identification, risk evaluation and loss prevention.

### EXAMPLE 10

### Use of Existing Social Networking Sites for Insurance Platform

Facebook has published extensive documentation on the core concepts of online social networking experiences. The Facebook core concept framework is a useful way of thinking about the system and method of providing insurance using an insurance facilitator. Social design is a way of thinking about product design that puts interactive experiences at the core. The insurance facilitator business model and associated technology will adhere to this social design concept. According to Facebook, social design defines how we understand ourselves and each other and can be broken down into three core elements: identity, conversation and community. Community refers to the people we know and trust and who help us make decisions. The insurance facilitator creates communities comprised of affinity insurance groups. conversation refers to the various interactions of people within communities. The insurance facilitator adds to existing online conversations in the context of risk and insurance. Identity refers to our own sense of self and how we are seen by our communities. The risk scoring and reputation algorithms will be an extension of pre-existing online identities.

Facebook has demonstrated that one way to model a social product is by working from the inside out: allow people to create an identity, let them share it and build community over time. Facebook began this way. The insurance facilitator will benefit from the pre-existing online communities and optionally has the advantage of working from the outside in: the insurance facilitator is able to utilize the existing community users have built, define new conversations around insurance and let the users continue to build their identities further.

In one embodiment, community Facebook profile data is used by the insurance facilitator to personalize the user experience. Communities feel familiar, relevant and trusted by default. Users will feel comfortable and engaged knowing their friends are already actively participating in an insurance group run by the insurance facilitator. When users join, the insurance facilitator automatically connects them to the friends who are already there, instead of making them search and add friends manually. Not only is this easier for the user, but it provides the insurance facilitator with social data at the start that helps engage the user.

The online platform run by the insurance facilitator will be transparent and will give users control. At the same time, the insurance facilitator ensures that users of the platform have control over the data they provide.

Using the Facebook concept of “building conversations”, the insurance facilitator builds tools and experiences that give people the power to connect and share, allowing them to effectively listen and learn from each other, within the new context of risk and insurance online conversations enable individuals to express their identities to communities and to receive feedback from the communities. According to Facebook, an effective conversation is based in two experiences: “listening”: displaying personalized content, social context and user activity, and “Speaking”: making it easy for users to talk, share, give feedback and engage. In embodiments, the insurance facilitator enables Listening and Speaking, this creating a positive feedback loop that has the potential to grow exponentially. Users are encouraged to participate when they can listen to and watch other active users on the platform. The platform will show a history of activity (highlighting friend activity) as an effective way to generate interest and conversation. Users will better understand what is expected of them and will likely seek out ways to participate.

Presenting information about the activity and actions of others is an effective and natural way to inform and engage other users. Users are far more likely to start engaging with the insurance facilitator by responding to content created by their friends than they are likely to create content their own. Because of this, in some cases the insurance facilitator has the capability to interact with nearly every piece of content in the platform, as every piece of content can be its own conversation topic.

The staff of the insurance facilitator, especially the Program Managers, assists users by curating identity: users share and interact with others because self-expression feels good and rewarding. The insurance facilitator assists the program managers to learn more about themselves and curate their identity, as it applies to insurance. According to Facebook, social design plays to the most powerful form of motivation: the self. People share and interact with communities because they want to, because they learn more about themselves and enjoy feeling known by their community. We know that creating and curating an identity within with the insurance facilitator will lead to a stronger emotional connection with the platform over time. Building a profile that represents a user's identity provides self-motivation and personal value to users.

In embodiments, the insurance facilitator takes advantage of two other key elements of the Facebook framework: authentication and social channels. The Facebook authentication enables the insurance facilitator to interact with the graph application programming interface (API) on behalf of Facebook users and will provide a powerful single sign-on mechanism across internet, intranet, mobile, and test top caps. The Facebook platform involves three different authentication steps: user authentication, app authorization and app authentication. User authentication ensures that the user is who they say they are. App authorization ensures that the user knows exactly what data and capabilities they are providing to the insurance facilitator. App authentication ensures that the user is getting their information to the insurance facilitator and not someone else. Once these steps are complete, the insurance facilitator is issued a user access token that enables it to access the user's information and take actions on their behalf.

The Facebook platform allows the insurance facilitator to integrate with social channels such as newsfeed to help drive growth and engagement with the platform. One benefit of using a platform such as Facebook or Linked In, or a corporate or university internal platform, is the potential access to prospective customers the insurance facilitator will have when users of the networking platform share content from their experience and insurance group with their friends. Because of the strength of a friend's endorsement, communication through a platform such as Facebook helps the insurance facilitator to grow.

At Facebook's core is the social graph; people and the connections they have, and everything they care about. The open graph will allow the insurance facilitator to model user activities based on actions and objects. With the open graph, the insurance facilitator becomes a part of the user's identity and social graph.

The principal benefits of the embodiments described herein are the provision of insurance at low cost, and stable cost across time. The disclosed embodiments also give policyholders much more control over many elements of their insurance programs. As people and businesses increasingly participate in one or more online networks, they will expect to use, and be capable of using, those networks for more and more tasks and functions. The embodiments described herein leverage the functionality in these networks to provide low cost insurance. Buyers of insurance want insurance products that meet their specific needs. The embodiments described herein allow the buyers to design and participate in the modification of their own insurance, and provide the buyers with control over which other buyers will be in their risk pools.

Buyers of insurance want low cost products with appropriate coverage, and want the costs to be relatively stable over time. The embodiments described herein provide insurance at a reduced cost relative to conventional insurance products because the marketing, purchasing and selling are internet or intranet-based, and the risk profiles are constantly being improved by leveraging the functions of online social networking. Buyers of insurance are increasingly doing all kinds of transactions over the Internet, and are increasingly participating in online social networks. They are likely to find it a natural extension to use internet-based and/or intranet-based social networks to obtain insurance.

### EXAMPLE 11

### Components of Online Delivery of Services and Products

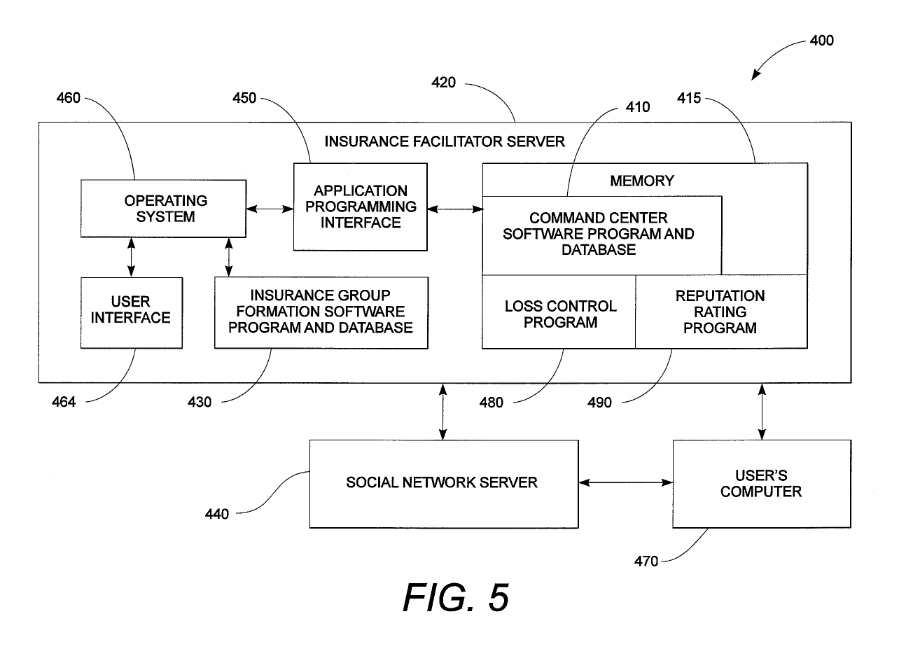

One embodiment of an insurance system 400, as shown in FIG. 5, involves (a) an internet or other network application and database that includes a command center software program and database 410 within and/or associated with an insurance facilitator server memory 415 that acts as a “command center” for the venture and most likely is located on the insurance facilities server 420, (b) an internet or other network application and database 430 for insurance group formation, which is most likely located on the insurance facilitator server 420 but also can be located on the social network server 440, that allows users to assemble groups and share data with the insurance facilitator, and (c) an API 450 within the network, most likely being primarily associated with the insurance facilitator server and being controlled by the operating system 460 for the insurance facilitator server 420 to facilitate communication between the server 420 and the server 440. The API also can support additional applications on the user's computer 470. The risk engine (loss control program 480) and reputation algorithm (reputation rating program 490) can sit inside the system, for example within the command center, or can reside with another part of the insurance system 400.

Applications are served up and processed through the internet or other network application by the affiliate group administrator or insurer. Policy communications, claims, etc. would be handled through conventional channels—this tool would serve to market and administer the membership component of the program. In embodiments, similar to other financial service related Facebook apps, no financial transactions or sensitive data will reside on the social network platform itself.

Some insurance programs on the insurance facilitator platform will be open only to persons or businesses that meet certain program criteria, or persons and businesses who are part of a homogeneous affinity group. For example, one program may be open to “persons who graduated from Rockport University between the year 2000 and the year 2011”. In such program circumstances, the user would also include in the candidate profile the necessary information to prove that it meets the general program criteria.

The data entered by the candidate is combined with the data obtained by the insurance facilitator from third-party sources of underwriting information. This new combined set of data constitutes the initial risk profile of the candidate. This risk profile is then presented by the insurance facilitator server back to the user's computer via the online social networking site. The user may then examine the risk profile for accuracy and correct any erroneous data elements. The user then indicates back to the insurance facilitator server that the risk profile is complete and that the user is interested in being considered for moving from candidate status to member status for a particular insurance program. The candidate will then receive a message from the insurance facilitator server informing the candidate of the date and time of the next member assembly. At the time of the member assembly, the user may use its computer to go to the online social networking site and monitor the results of the voting process taking place at the member assembly. The candidate will then be informed by the insurance facilitator server via the online social networking site whether or not the candidate has received a majority vote of the other members in order to move from candidate status to member status.

If the user is voted in as a member to the insurance program, the member sends a message from their computer to the insurance facilitator server confirming that they want to accept insurance coverage, subject to the cost and coverage details that are not already available and known. The user then receives data from the insurance facilitator server with details on the insurance coverage, effective date, premiums, and reporting requirements. The member also receives from the insurance facilitator server an electronic copy of the insurance policy. At this point, the member receives data from the insurance facilitator server on the composition of the other members of the insurance program and the new member now has viewing access to the risk profiles and risk reputations of other members. The member receives instructions from the insurance facilitator server on how to participate in member assemblies on a going forward basis. Additionally, the member receives from the insurance facilitator server invitations to provide input into risk management, and loss control materials including wikis, videos, blogs, and other online media that are being used by the members to share experiences related to insurance and loss control. The insurance facilitator monitors what is shown to keep out incorrect material, opinions not supported by stated facts, and criticism of other members.

In embodiments, the member is able to use its computer to access information via the online social networking site that is provided by the insurance facilitator server regarding when premiums are due and the status of the member's account. In many cases, the user is able to receive data from the insurance facilitator via the online social networking site pertaining to periodic changes to the user's risk reputation, as a consequence of future (favorable or unfavorable) loss experience, and future participation in the development of informational materials for other members on insurance and loss control topics. The user may also update its own risk profile with current information.

When the initial term of insurance is coming up for expiration, the member will also receive data from the insurance facilitator via the online social networking site on how to participate in the next member assembly in order to continued to receive insurance coverage.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, or a combination thereof.

I claim:

1. A system for providing insurance policies, comprising:
at least one insurance database storing user information for a group of users in an insurance program, including user identity data and user reputation data,
an insurance program server containing an insurance platform application communicating with the users in the insurance program through a social network web site and accessing user identity data through a social network database, the application providing insurance policies issued by an insurance carrier to the users covering a first insurance policy term, and using risk reputation rating data about an individual user submitted by the individual user and scored by the insurance platform application, the platform application providing individual user reputation data to other users for the purpose of removing selected users from the group for a second insurance policy coverage term.

2. The system of claim 1, wherein the insurance policies are automobile insurance policies.

3. The system of claim 1, wherein the insurance policies are renter's insurance policies.

4. The system of claim 1, wherein risk reputation rating data comprises numerical data associated with a user, and a user is removed from the group if the user's risk reputation rating is below a certain value.

5. The system of claim 1, wherein the periodic insurance premium for a particular user is based in part upon the risk reputation rating data.

6. The system of claim 1, wherein the insurance program server includes an application for member reputation management.

7. The system of claim 1, wherein the insurance program server is operated by an insurance facilitator that is separate from the insurer.

8. A method of managing an online insurance program, comprising:
forming a first electronic user group of at least 50 users, managed by an insurance program facilitator, in which each user contributes a predetermined first quantity of funds and/or services and receives a first commodity in exchange for the funds and/or services,
after a determined time period, receiving computerized instructions from the users in the group for removing selected members from the electronic user group,
removing the selected members from the electronic user group to form a revised electronic user group,
using a first computerized simulation to transform data representative of the cost of the commodity per user for a particular time period for the users in the revised electronic user group,
disseminating the transformed data to the insurance program facilitator, and
providing a second commodity to the members of the revised user group in exchange for a second quantity of funds and/or services contributed by each member of the revised user group.

9. The method of claim 8, further comprising, before receiving computerized instructions from the users in the group,
using a second computerized simulation to transform data representative of the cost of the commodity per user for the first electronic user group for a particular time period and disseminating the transformed data to the insurance program manager.

10. The method of claim 8, wherein the commodity is an insurance policy.

11. The method of claim 10, wherein the insurance policy is an automobile insurance policy.

12. The method of claim 10, wherein the insurance policy is a renter's insurance policy.

13. The method of claim 8, wherein the insurance facilitator provides an online risk management forum in which the content of the forum is generated by members of the first electronic user group.

14. A method, comprising:
identifying a group of potentially insurable individuals,
providing a third party administrator,
configuring the individuals in the group and the third party in a hub arrangement,
providing insurance at a first premium rate to a subset of the individuals through a carrier using the third party administrator,
sending a query to the insured individuals at a future time to determine which members of the group are to be removed from the group,
receiving data from the individuals in the group indicative of insured individuals to be removed from the group,
removing selected individuals from the group,
using computerized simulation to transform historical loss data and perform one-tail tests on the data, and
providing insurance at a second premium rate that is lower than the first premium rate to the subset of individuals.

15. A system for implementing the method of claim 8.

16. A system for implementing the method of claim 14.

17. A computer system comprising:
a data storage memory, an operating system for accessing data in the memory, an application program compatible with the operating system and a user interface for the operating system and application program, wherein the system comprises:
a database stored in the memory containing member data, at least a portion of the data included in the database presenting a quantitative indicator value indicative of the level of risk for insuring a particular individual,
executable instructions for combining with weighted importance, the quantitative indicator values of the group members,
executable instructions for computing insurance premium data for the group with and/or without including the riskiest members of the group, and
executable instructions for receiving votes to remove group members to reduce group risk.

18. The method of claim 17, wherein the insurance premium is at least one of an automobile insurance premium and a renter's insurance premium.

19. A method of establishing an insurance pool comprising:
obtaining potential insurance pool member profiles over the internet using a social network accessible using a computer,
sending electronic invitations to potential insurance pool members to join an insurance network that is a subgroup of the social network, and
managing insurance member network reputations, and/or providing rewards to members for network participation,
wherein the insurance pool is established and managed using a computer, and group members can remove particular group members by voting.

20. An insurance program or system according to claim 18, wherein the type of insurance provided includes at least one member selected from the group consisting of worker's compensation, commercial property, commercial general liability, commercial auto, personal auto, personal homeowner's, personal renter's, short-term disability, long-term disability and life.
